(19) United States
(12) Patent Application Publication
(10) Pub. No.: US 2026/0353023 A1
(43) Pub. Date: Nov. 5, 2026

(54) RANGE AND ABSOLUTE ORIENTATION FROM ULTRASONIC SIGNALS

(71) Applicant: InvenSense, Inc., San Jose, CA (US)

(72) Inventors: Richard Przybyla, Piedmont, CA (US); Nathan Lester, Ashland, MA (US); Robert Louis Dick, Ipswich, MA (US)

(21) Appl. No.: 19/361,279

(22) Filed: Oct. 17, 2025

Related U.S. Application Data
(60) Provisional application No. 63/769,042, filed on Mar. 9, 2025.

(51) Int. Cl. H04S 7/00; G01S 15/66

(52) U.S. Cl. CPC H04S 7/301; G01S 15/66

(57) ABSTRACT

A user device such as a headset includes multiple microphones located at known locations on the headset. An ultrasonic emitter remote from the user device transmits an ultrasonic signal that is received at the microphones. The user device and the ultrasonic transmitter perform a synchronization such that the transmission time of the ultrasonic signal is known. The microphones receive the ultrasonic signal at different times based on their location relative to the ultrasonic emitter. Based on the known transmit time and the receive times of the ultrasonic signal at the microphones, spatial information about the user device is determined.

### BACKGROUND

Spatial orientation systems are integrated into various components including home stereo equipment, headsets, augmented/virtual reality systems, gaming controllers, and the like. Initial set-up of devices for spatial orientation requires users to manually calibrate a starting location for orienting the device. This may require multiple steps, such as the user being positioned in a particular location with the device in a specific orientation. Subsequent changes in position can be updated by accelerometers and/or gyroscopes resident on the device.

The requirement for manual calibration by a user is burdensome and reduces positional accuracy. Reliance on the user to manually set their initial location can be inconvenient, error-prone, and subject to inconsistency, especially if the user's setup environment changes or if multiple users share the system. Furthermore, while the accelerometers and/or gyroscopes can provide continuous tracking, these systems are inherently susceptible to drift over time due to the accumulation of small measurement errors. Without an external reference to correct these deviations, the perceived location of the user can gradually become inaccurate, causing the spatial audio to misalign with actual head movements and environmental cues. This degradation in spatial coherence can reduce the realism of the experience, potentially leading to user discomfort or a loss of immersion.

### SUMMARY

In an embodiment of the present disclosure, a method of determining spatial information for a device comprises receiving, at the device, a synchronization signal, and determining, based on the synchronization signal, a time of transmission for an ultrasonic emitter located at a first location remote from the device. The method further comprises receiving, at a microphone of the device, an ultrasonic signal, determining that the received ultrasonic signal is from the ultrasonic emitter, and identifying a receive time of the received ultrasonic signal when the received ultrasonic signal is determined to be from the ultrasonic emitter. The method further comprises determining the spatial information based on the time of transmission and the receive time, wherein the spatial information includes at least a range between the device and the first location.

In an embodiment of the present disclosure, a user device comprises a plurality of microphones, a radio frequency (“RF”) transceiver, an inertial measurement unit (“IMU”), a memory comprising instructions stored thereon, and processing circuitry coupled to the plurality of microphones, the RF transceiver, the IMU, and the memory. The processing circuitry is configured to execute the instructions to receive a synchronization signal at the RF transceiver and determine, based on the synchronization signal, a time of transmission for an ultrasonic emitter located at a first location remote from the user device. The processing circuitry is further configured to execute the instructions to receive, at each microphone of the plurality of microphones, an ultrasonic signal, identify a first receive time of the received ultrasonic signal at a first microphone of the plurality of microphones, and identify a second receive time of the received ultrasonic signal at a second microphone of the plurality of microphones. The processing circuitry is further configured to execute the instructions to determine spatial information for the user device based on the time of transmission, the first receive time, and the second receive time, wherein the spatial information includes at least a range between the user device and the first location.

In an embodiment of the present disclosure, a system comprises an ultrasonic emitter and a user device, wherein the ultrasonic emitter is located at a first location remote from the user device. The user device comprises a plurality of microphones, a radio frequency (“RF”) transceiver, an inertial measurement unit (“IMU”), a memory comprising instructions stored thereon, and processing circuitry coupled to the plurality of microphones, the RF transceiver, the IMU, and the memory. The processing circuitry is configured to execute the instructions to receive a synchronization signal at the RF transceiver and determine, based on the synchronization signal, a time of transmission for the ultrasonic emitter. The processing circuitry is further configured to execute the instructions to receive, at each microphone of the plurality of microphones, an ultrasonic signal, identify a first receive time of the received ultrasonic signal at a first microphone of the plurality of microphones, and identify a second receive time of the received ultrasonic signal at a second microphone of the plurality of microphones. The processing circuitry is further configured to execute the instructions to determine spatial information for the user device based on the time of transmission, the first receive time, and the second receive time, wherein the spatial information includes at least a range between the user device and the first location.

### BRIEF DESCRIPTION OF DRAWINGS

The above and other features of the present disclosure, its nature, and various advantages will be more apparent upon consideration of the following detailed description, taken in conjunction with the accompanying drawings in which:

FIG. 1 shows an illustrative spatial orientation environment;

FIG. 2 depicts an exemplary spatial orientation system in accordance with an embodiment of the present disclosure;

FIG. 3A depicts a first side of an exemplary user device in accordance with an embodiment of the present disclosure;

FIG. 3B depicts the opposite side of the exemplary user device shown in FIG. 3A in accordance with an embodiment of the present disclosure;

FIG. 4 depicts a system diagram of an exemplary device having a signal emitter in accordance with an embodiment of the present disclosure;

FIG. 5 depicts a system diagram of an exemplary user device in accordance with an embodiment of the present disclosure;

FIG. 6 depicts exemplary steps of synchronization and range and orientation determination for the user device in accordance with an embodiment of the present disclosure;

FIG. 7 depicts exemplary steps of synchronization and range and orientation determination for the user device in accordance with another embodiment of the present disclosure; and

FIG. 8 depicts exemplary steps of updating range and orientation information for the user device in accordance with an embodiment of the present disclosure.

### DETAILED DESCRIPTION

Many modern electronic devices like home stereo systems, headsets, virtual reality gear, and game controllers use technology that tracks where they are in space. This helps the devices know which direction a person is facing or moving in, so they can adjust sounds or images accordingly. When one of these devices is first used, it requires manual set-up. For example, a person is required to stand or sit in a specific way and hold the device in a particular way so it knows a “starting” location. This setup can be difficult and time-consuming, and is not always accurate, especially if the environment changes or different people take turns using the same system. After the initial setup, the device uses built-in motion sensors (e.g., accelerometers and gyroscopes) to keep track of how it moves. But even when using those sensors measurements may slowly get less accurate over time, for example, due to small errors accumulating over time. Small errors build up, and without a way to correct them, the system starts to think the user is in a different position or orientation compared to the actual position or orientation. When that happens, things like 3D sound or visuals may not match where you are looking or moving. This can make the experience less real, or even confusing, and might even cause discomfort or make the experience less enjoyable.

According to the present disclosure, an ultrasonic time-of-flight (ToF) system is provided for a device to determine exactly where it is in a room, without requiring user input. The system has a source (i.e., a beacon) that generates ultrasonic signals from a first location (e.g., on a device such as a speaker) in the room. So long as the user device is within range of the ultrasonic signal, the ultrasonic signal is received at microphones of the user device. With multiple microphones located at different positions, the microphones receive the ultrasonic signal at slightly different times depending on how far away they are from the source. The user device utilizes these differences in timing along with the known relative positions of the microphones on the user device to determine information such as location and orientation.

Because the user device has more than one microphone each at a known relative location, it can compare when each one receives the ultrasonic signal. This helps the device not only figure out how far away it is from the beacon, but also the orientation of the device relative to the beacon. All of this happens automatically and in real-time. As the user moves around, the device determines (e.g., periodically) its location and orientation by listening to these ultrasonic signals and doing the math to keep track of where it is. Combined with other systems such as dead reckoning (e.g., using accelerometers and gyroscopes), such a system is useful for applications like spatial audio and augmented reality experiences, or other applications where relative location and orientation within an area are important.

As described in one example embodiment, a spatial audio system with a headset uses received ultrasonic signals and their respective timing at multiple microphones to figure out exactly where the headset is in a room as well as its orientation, allowing the headset to deliver sound in a way that matches the listener's surroundings. This makes the audio feel like it is coming from specific places in space, such as a voice behind you or music playing to your left, even though it is coming from the speakers inside the headset. The headset listens to high-frequency ultrasonic signal waves to know where the listener is and how the listener is moving.

In an example system, the source (i.e., the beacon) is at a known location in the room and sends out ultrasonic signals into the adjacent environment. The headset, which the user wears, has several built-in microphones placed at different locations. When the beacon sends out an ultrasonic signal, the microphones on the headset receive it at slightly different times based on their respective locations. The system uses these timing differences to figure out how far away the beacon is from each of the microphones. Because the headset has multiple microphones, it can also figure out which direction the ultrasonic signal came from. By comparing when each microphone received the ultrasonic signal, the system calculates the location of the headset, including its range and orientation (e.g., corresponding to which way the user is facing or tilting their head). As the person wearing the headset moves around the room, the system keeps listening for ultrasonic signal transmissions to update the headset's location, thus updating information determined by dead reckoning with absolute position and orientation. This allows the audio to adjust in real time. For example, if someone turns their head, a sound that was originally in front of them will now seem to come from the side, just like it would in real life. This makes the experience much more immersive and realistic.

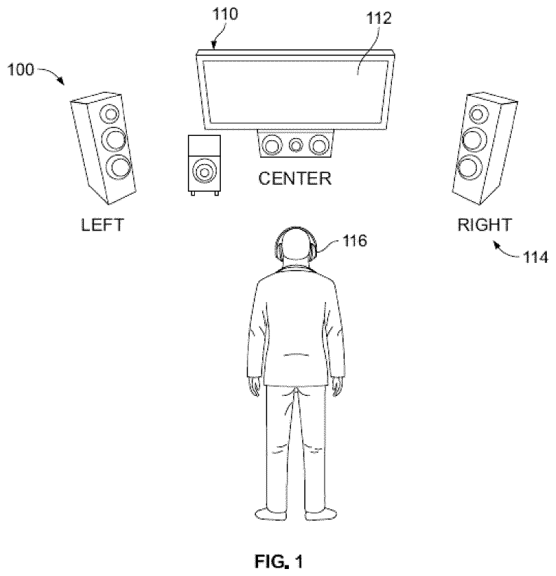

FIG. 1 depicts conventional entertainment environment 100 including a central display 110, such as a television 112, surrounded by an array of strategically positioned speakers 114 and a device, such as a user-worn headset 116. Television 112 often serves as the focal point for both visual and audio content, while speaker array 114 is arranged in a surround sound configuration and delivers audio that simulates real-world acoustics. These speakers 114 are placed around the listener to create a three-dimensional sound field, allowing for directional audio perception that matches the on-screen action. Headset 116, equipped with built-in headphones and sensors, may provide spatial audio information in coordination with speakers 114.

Headset 116 may be used to enhance personalized spatial audio, particularly when the user's location changes. Accurate spatial audio rendering improves based on the precision of information regarding the user's location relative to the audio sources (e.g., the TV and speakers). At the beginning of the experience, the user is often asked to manually set or confirm their location—this might involve standing in a predefined spot, using a calibration tool, or aligning themselves using on-screen instructions. This initial setup is essential to define the reference point from which spatial audio effects can be rendered correctly. Without this calibration, the spatial cues might be misaligned, leading to an unnatural or confusing auditory experience.

Once the initial location is established, the system can utilize an Inertial Measurement Unit (IMU) embedded within headset 116 to track the user's movements. The IMU comprises accelerometers, gyroscopes, and sometimes magnetometers, which collectively measure changes in orientation and motion. By continuously monitoring head position and rotation, the system dynamically adjusts the audio rendering to maintain accurate spatial cues. For instance, if the user turns their head to the right, the sound source that was originally in front now appears to come from the left, and the system updates the sound direction accordingly. This integration of manual calibration and real-time tracking enables immersive and consistent spatial audio experiences, enhancing the realism and engagement of multimedia content.

Despite its immersive capabilities, the conventional spatial audio system has notable shortcomings, particularly in terms of user burden and positional accuracy. One primary limitation is the reliance on the user to manually set their initial location relative to television and speaker array 112, 114. This process can be inconvenient, error-prone, and subject to inconsistency, especially if the user's setup environment changes or if multiple users share the system. Furthermore, while the IMU in headset 116 provides continuous tracking, it is inherently susceptible to drift over time due to the accumulation of small measurement errors. Without an external reference to correct these deviations, the perceived location of the user as determined by the system can gradually become inaccurate, causing the spatial audio to misalign with actual head movements and environmental cues. This degradation in spatial coherence can reduce the realism of the experience, potentially leading to user discomfort or a loss of immersion.

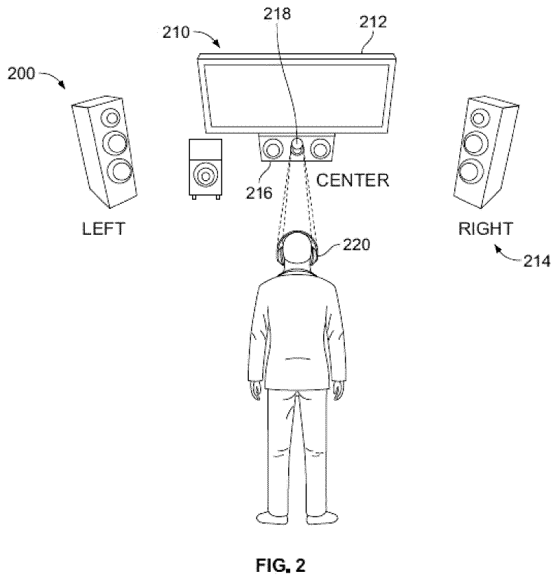

FIG. 2 shows a system 200 for determining spatial information for a user in accordance with an embodiment of the present disclosure. Although FIG. 2 will be described in the context of a spatial audio system, it will be understood that the present disclosure may be utilized with a variety of different applications and systems where a known spatial orientation of a person or object is useful. Although particular components are depicted and described in FIG. 2, it will be understood that components may be added, removed, substituted, or modified in accordance with the present disclosure.

In the example depicted in FIG. 2, system 200 incorporates advanced sensing technologies to automate and refine user localization. System 200 includes a central display 210, such as a television 212, a speaker array 214 including a soundbar 216, a time-of-flight (ToF) device 218, and a user device 220. ToF device 218 is located at a fixed location relative to the other components in system 200, providing a known orientation of ToF device 218 relative to television 212 and speaker array 214. In the example embodiment, ToF device 218 includes an ultrasonic emitter (or beacon) and user device 220 is a wearable device that provides a spatial orientation of a user 222 relative to one or more components of system 200. ToF device 218 sends an ultrasonic signal that is received by microphones at user device 220 to establish the location of user device 220 relative to other components in system 200.

ToF device 218 allows the initial location of the user to be established automatically, without requiring the user to stand in a predefined spot, use a calibration tool, or align themselves using on-screen instructions. Further, because manual calibration is not required, position information can be updated (e.g., periodically and/or based on the occurrence of predetermined events) during use without inconvenience to the user, thus correcting for any drift in a dead reckoned position as determined by an IMU of the user device 220. Based on the time between transmission of the ultrasonic signal from ToF device 218 and receipt by microphones user device 220, the distance (i.e., range) between ToF device 218 and user device 220 can be determined. Accordingly, based on the known location of ToF device 218 relative to the other components in system 200, user location can also be determined relative to those system components.

User device 220 can also provide relative orientation of the user relative to components of system 200. User device 220 can have multiple microphones that receive the ultrasonic signal from the ultrasonic emitter of ToF device 218. The relative orientation of a user wearing user device 220 can be determined based on the relationship between the time the ultrasonic signal is received at each microphone. For example, if user device 220 has two microphones at corresponding locations (e.g., at the same location on each of a right-side and left-side cup of a headset) and the ultrasonic signal is received at the same time at both microphones, the user device 220 can be considered as facing toward or away from ToF device 218. In such an example with corresponding microphone locations on each side of a headset, if the time of ultrasonic signal receipt at the microphones differ, user device 220 is orientated at an angle relative to ToF device 218. As described herein, different information can be determined based on a number of microphones and relative locations of the microphones (e.g., vertically, laterally, etc.) on the user device 220.

The range and orientation determination discussed above can provide an initial location for user device 220 relative to other components in system 200. Like the arrangement discussed in connection with FIG. 1, once the initial location is established, system 200 can utilize a sensor (e.g., an inertial measurement unit (IMU)) embedded within user device 220 to track the user's movements and update characteristics of system 200 based on user location. By continuously monitoring range and orientation, system 200 dynamically adjusts to maintain accurate spatial cues. This can be used in a variety of applications, such as spatial audio systems, and may be used when calibrating a surround sound system. For example, when user device 220 is a headset, it may be used to simulate the sound field that would be present if system 200 were used (i.e., spatial audio). For calibration, the user can wear user device 220 (e.g., a headset) and be asked to walk around the room while his position is tracked and user device 220 records the test signals from system 200. This interaction can be used to tune the response of system 200 to account for the reverberations in the room.

In addition to overcoming the inconvenient and error-prone manual location initialization, system 200 provides greater accuracy during use. For example, while the IMU in user device 220 provides continuous tracking, it is inherently susceptible to drift over time due to the accumulation of small measurement errors. Without an external reference to correct these deviations, the perceived location of the user can gradually become inaccurate, causing the spatial audio to misalign with actual head movements and environmental cues. This degradation in spatial coherence can reduce the realism of the experience, potentially leading to user discomfort or a loss of immersion.

System 200 provides an arrangement where user location (orientation/range) is corrected (e.g., periodically and/or based on the occurrence of events such as amount of movement determined by IMUs, changes in sound characteristics of a source media, etc.) using ToF device 218. ToF device 218 can re-send the initialization ultrasonic signal and user device 220 can reset its location based on that signal or be triggered to resend the ultrasonic signal such as by information sent via another communication medium (e.g., a message or other wireless signal sent such as by Bluetooth or WiFi).

ToF device 218 can be a stand-alone device or can be incorporated into another device of system 200. In the example embodiment discussed further below, ToF device 218 can be incorporated into a soundbar, such as soundbar 216, to allow system 200 to leverage the capabilities of the transceiver in soundbar 216 for synchronizing the ultrasonic signal from ToF device 218. Alternatively, ToF device 218 may have its own transceiver or other way to synchronize ultrasonic emissions with user device 220. For example, ToF device 218 and user device 220 can each have an ultrasonic transceiver arrangement to enable two-way communication for synchronization using ultrasonic pulse transmissions in a pitch/catch arrangement. Additionally, ToF device 218 can have its own radio frequency (RF) module, such as a Bluetooth, WiFi, or other wireless communication module. Due the respective characteristics of RF and ultrasonic communications, the transmission of RF signals between the ToF device 218 and the user device 220 is negligible compared to ultrasonic transmissions, allowing information to coordinate ultrasonic signals for location and orientation to be coordinated via RF transmissions.

It is understood that ToF device 218 could have a single ultrasonic emitter (beacon) at a fixed location or could include multiple emitters (beacons) spaced from one another at known points in space to provide increased positioning capabilities (e.g., trilateration) for user device 220. When multiple ultrasonic emitters (beacons) are used, the coordinate location of user device 220 in space can be determined. Multiple emitters can be arranged to form a triangle from the user's point of view (e.g., to establish trilateration). For example, one emitter can be on soundbar 216, and second and third emitters can be below the bottom speakers on the right and left speakers, respectively, in speaker array 214. The three emitters can be arranged, such that the three emitters are not placed in a line.

User device 220 can take various forms, including a headset, an augmented/virtual reality device, glasses, a gaming controller, a phone, a smartwatch, or some other form of user-held or wearable device. Other forms that user device 220 can take include a keyboard, remote control, mouse, air mouse, tablet, or laptop. In the example embodiment, system 200 is a spatial audio system that modifies a user's audio experience based on user movement. The modified audio output may be experienced at one or more of television 212, speaker array 214, or user device 220. For example, as the user moves, the sound provided at various portions of speaker array 214 and/or user device 220 may be modified based on the user's location.

Alternatively, or additionally, user device 220 may have speakers that provide modified output based on user location. In the example embodiment of FIG. 2, television 212, with soundbar 216 and ToF device 218 located directly below, may serve as the focal (or anchor) point for both visual and audio content. Based on the known orientation of user device 220, if the user turns their head to the right, the sound source that was originally in front now appears to come from the left, and the system updates the sound direction, providing immersive and consistent spatial audio experiences, enhancing the realism and engagement of multimedia content.

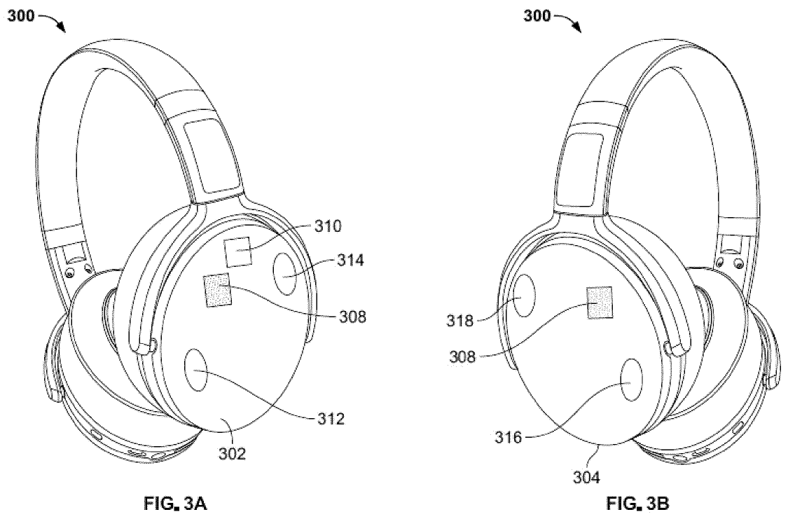

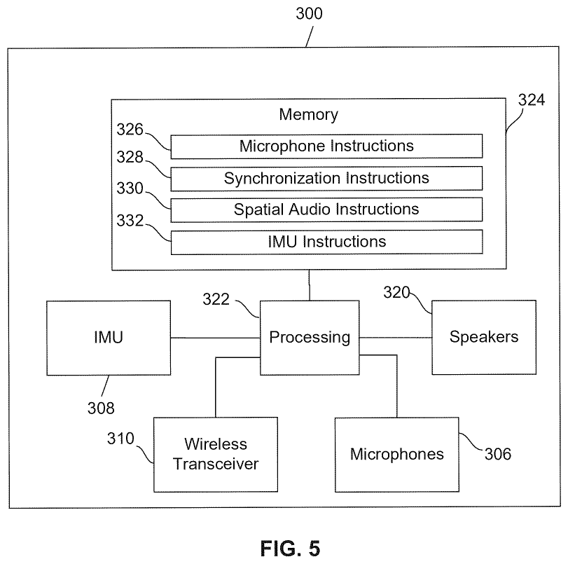

FIGS. 3A, 3B, and 5 depict an example embodiment of user device 220 as an active noise cancelling headset 300. In some embodiments, the user device 220 may be a conventional active noise cancelling headset, requiring only updates to firmware to accommodate the use of the ultrasonic signals provided for initialization of location. In such an example arrangement, headset 300 includes left and right ear cups 302, 304, an external array of microphones 312, 314, 316, 318 at known locations capable of ultrasonic signal detection, one or more inertial measurement units (IMU) 308 (e.g., 6-axis IMU with a 3-axis gyroscope and a 3-axis accelerometer), and a wireless transceiver 310 (e.g., a radio frequency (RF) module, such as a Bluetooth module). In some embodiments, wireless transceiver 310 may include an ultrasonic emitter or transceiver in place of, or in addition to, the RF module. Headset 300 may include front and rear external microphones 312, 314 on left ear cup 302 and front and rear external microphones 316, 318 on right ear cup 304 that capture audible sounds as well as ultrasonic signals.

Although the example embodiment described uses a headset having four microphones and two IMUs, fewer microphones and/or IMUs may be used. For example, as discussed above in connection with FIG. 2, a single microphone may be used to determine range and as few as two microphones may be used to determine orientation, while three or more microphones may provide greater resolution regarding range and orientation.

FIG. 5 depicts a system diagram of headset 300. Headset 300 includes microphones 306 (i.e., collectively, microphones 312, 314, 316, 318), IMU 308, wireless transceiver 310, a speaker 320 for each ear cup 302, 304, processing circuitry 322, and memory 324. Processing circuitry 322 may include a processor such as a microprocessor that executes software instructions (e.g., that are stored in memory 324). The microprocessor may control the operation of wireless transceiver 310 and speakers 320. In some embodiments, some or all functions of the processing circuitry 322, and in some embodiments, memory 324, may also be present on the microprocessor, or be implemented on an application specific integrated circuit (“ASIC”) and/or a field programmable gate array (“FPGA”). Memory 324 includes microphone instructions 326, synchronization instructions 328, spatial audio instructions 330, and IMU instructions 332.

Microphone instructions 326 may govern signal flow, preprocessing, synchronization, and classification of incoming acoustic data. Microphone instructions may include pulse detection algorithms, which scan the incoming signal stream for recognizable ultrasonic pulses that meet predefined criteria (e.g., specific modulation patterns or timing intervals). Microphone instructions 326 may identify a valid pulse by evaluating the waveform signature of the ultrasonic signal and matching the waveform signature with a given ToF device. Upon detecting a valid pulse, microphone instructions 326 record the timestamp of arrival for ToF calculations. Microphone instructions 326 may determine distances to each of the microphones using the recorded timestamp based on the given synchronization technique employed.

Synchronization instructions 328 may determine the exact time of the ultrasonic signal transmission from the sending device. In an example embodiment, where an out-of-band synchronization is used, synchronization instructions 328 may record the arrival time of an RF signal sent at the same time as the ultrasonic signal. Because the RF signal arrives almost instantaneously, the arrival time of the RF signal can be used to determine the transmission time of the ultrasonic signal for ToF calculations.

Synchronization instructions 328 may also periodically coordinate re-initialization of the location of headset 300 with a ToF device to minimize drift. Synchronization instructions 328 can also include instructions to decode a synchronization feature encoded in the waveform, such as a sharp rising edge or envelope change, a predefined modulation pattern, or a unique ultrasonic signal that marks the start of transmission. In some embodiments, where in-band synchronization is employed, synchronization instructions 328 may include instructions to decode the signal to determine the embedded transmission time. Examples of in-band synchronization can be found in U.S. Pat. Nos. 10,901,064 and 11,543,486, the disclosures of which are incorporated by reference in their entirety.

In an arrangement where headset 300 includes an ultrasonic emitter or transceiver, synchronization instructions 328 may include instructions for sending an ultrasonic pulse. For example, the synchronization instructions 328 may include evaluating the waveform signature of a received ultrasonic signal (e.g., from ToF device 218 or soundbar 400) and matching the waveform signature with a given ToF device to determine if a synchronization event has been initiated. The instructions may additionally include reply signal details, such as a fixed delay time after reception of the synchronization pulse and the specific waveform to send after the set delay in response to the received signal.

Alternatively, headset 300 could send the ultrasonic signal for initiating synchronization. In such an arrangement, synchronization instructions 328 may also include information regarding the specific waveform to send and instructions that record the transmission time. The instructions discussed in connection with receiving the ultrasonic signal from a ToF device may also be included in this arrangement with the addition of recording the reception time and determining the round-trip signal time (e.g., the difference between the time of initial signal transmission from headset 300 to when the reply signal is received, minus the fixed delay). The travel time (i.e., one-half of the round-trip time) of the ultrasonic signal may be saved for subsequent ToF calculations at each microphone.

Spatial audio instructions 330 may generally coordinate sound at speakers 320 in left and right ear cups 302, 304 based on a relative location and orientation of headset 300. Spatial audio instructions 330 provide commands or data that enable headset 300 to render sound in a way that mimics how sound is perceived in three-dimensional space. In the example embodiment, spatial audio instructions 330 generally include information about the location and movement of sound sources relative to the listener's head based on the known location of headset 300 using the distance information provided by microphone instructions 326.

Spatial audio instructions 330 can update the spatial rendering in real time as the user moves, turns, or tilts their head, maintaining the illusion of fixed sound sources in space. Spatial audio instructions 330 dynamically control sound output based on the listener's head position and orientation, using real-time data. When a user moves, turns, or tilts their head, the spatial audio instructions 330 recalculate locations and intensities of virtual sound sources accordingly.

Additionally, spatial audio instructions 330 can include information from an environment describing where each sound originates and how it should behave in response to user movement or environmental changes to dynamically shape the sound field to match how the sound would be heard in the real world. For example, if a sound is supposed to originate from the left side of the listener and the user turns their head to the right, the spatial audio instructions 330 will adjust the output so that the sound continues to appear as if it's still coming from the same fixed point in space, which is now located behind the user's head. This continuous recalibration ensures that the auditory illusion remains stable and convincing, creating the perception that certain sounds are anchored in specific spatial locations, independent of the listener's movements. In alternate arrangements, spatial audio instructions 330 may be located remote from headset 300 and provided to headset 300 from an external source (e.g., soundbar 400).

IMU instructions 332 may govern how IMU 308 is initialized, calibrated, sampled, and integrated with headset 300, ensuring that the spatial audio rendering remains tightly aligned with the user's head movements. This maintains the illusion of fixed-location sound sources in space, even as the listener turns, tilts, or moves their head. IMU instructions 332 handle the continuous acquisition of motion data and ensure synchronized sampling of all six axes (e.g., 3 axes of linear acceleration and 3 axes of angular velocity), applying digital filters (e.g., low-pass or complementary filters), for example, to remove high-frequency noise or irrelevant movement artifacts.

IMU instructions 332 may also manage motion event detection and error correction. Motion event detection includes routines to identify quick turns, nods, tilts, or sustained head movements, which may trigger adaptive changes in audio rendering, microphone sensitivity, or user interface feedback. For example, if headset 300 detects a sudden head turn, it may prioritize lower-latency updates. IMU instructions 332 may also monitor for sensor drift or degradation, using periodic recalibration logic or reference comparisons against other spatial data sources, such as ultrasonic ToF initialization, to correct long-term orientation errors. In one example, a Kalman filter can be used to track the position, velocity, quaternion, and angular velocity of headset 300 with respect to ToF device 218. The IMU data can be fused with the ultrasonic range data using the Kalman filter. With appropriate tuning, the Kalman filter will track the quick movements captured by IMU 308, while rejecting the long-term drift. An example can be found in U.S. Pat. No. 10,545,219, the entirety of which is incorporated by reference.

Although discussed in connection with headset 300, it is understood that similar arrangements may be provided for other user devices including augmented/virtual reality headset, glasses, a gaming controller, or some other form of user-held or wearable device having microphones capable of receiving ultrasonic pulses and determining the orientation of the device based on those ultrasonic signals in manners similar to those discussed above in connection with headset 300.

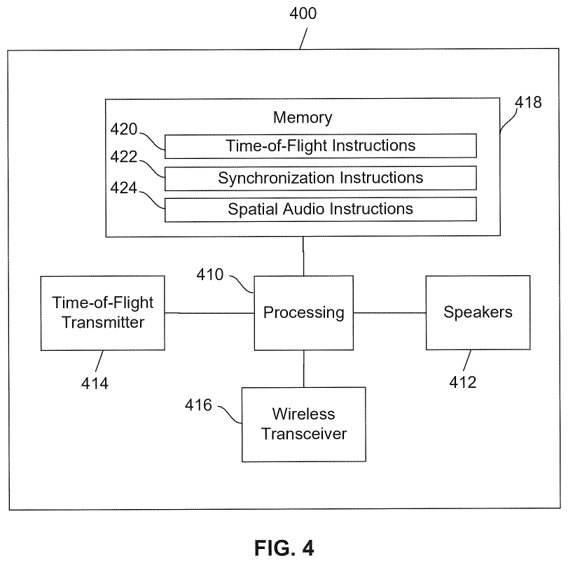

As noted above, a ToF device capable of sending ultrasonic pulses may be incorporated into another device in system 200, such as a soundbar. FIG. 4 depicts an exemplary soundbar 400 according to such an example embodiment. Soundbar 400 may be incorporated into system 200 as soundbar 216 and time-of-flight (ToF) device 218. Soundbar 400 includes processing circuitry 410, speakers 412, ToF transmitter 414, wireless transceiver 416, and memory 418. Processing circuitry 410 may include a processor such as a microprocessor that executes software instructions (e.g., that are stored in memory 418). The microprocessor may control the operation of speakers 412, ToF transmitter 414, and wireless transceiver 416. In some embodiments, some or all functions of the processing circuitry 410, and in some embodiments, memory 418, may be implemented on an application specific integrated circuit (“ASIC”) and/or a field programmable gate array (“FPGA”). Memory 418 includes ToF instructions 420, synchronization instructions 422, and spatial audio instructions 424.

In the example embodiment, ToF transmitter 414 includes an ultrasonic emitter. ToF transmitter 414 generates ultrasonic pulses using piezoelectric transducers, for example, that convert electrical signals into mechanical vibrations. The pulses may be designed with a specific waveform (e.g., a burst of sine waves) to enhance signal processing, reduce noise, and allow for better differentiation. In some embodiments, ToF transmitter 414 may be in the form of an ultrasonic transceiver that provides two-way ultrasonic communication with headset 300 for functions like synchronization.

Wireless transceiver 416 functions as a wireless transmitter and receiver to enable two-way communication with radio frequency (RF) signals. In the example embodiment, wireless transceiver 416 is a Bluetooth module. Wireless transceiver 416 allows soundbar 400 to communicate with other Bluetooth-enabled devices, such as providing communication between soundbar 400 and headset 300. In addition to the normal functionality provided by wireless transceiver 416 in soundbar 400, wireless transceiver 416 may transmit a synchronization signal to headset 300 to coordinate the timing of the ultrasonic signal provided by ToF transmitter 414. The synchronization signal may indicate a start time of the signal emission from the ToF transmitter 414.

ToF instructions 420 may command the ultrasonic signal generation by ToF transmitter 414 at a known and precise time. In the example embodiment, ToF instructions 420 set parameters, such as the ultrasonic pulse frequency, number of waveform cycles, and output duration. ToF instructions 420 may command the generation of the ultrasonic pulse at a timed schedule or in response to a trigger event. Upon emission, ToF instructions 420 may log the exact timestamp of the ultrasonic pulse and may enter a fixed delay period or await the next trigger before repeating the process.

ToF instructions 420 may repeat (e.g., periodically and/or based on other criteria such as identification of critical portions of media, receipt of messages from a headset 300 requesting synchronization, etc.) ultrasonic pulse transmission to re-initialize range and orientation information of headset 300 and minimize error due to drift from reliance solely on IMUs 308 in headset 300. Repeat transmission may occur at set time intervals, may be manually initiated by a user if an error in orientation is perceived, or may be set based on occurrence of predetermined events. ToF instructions 420 may also command a specific waveform that is identifiable with ToF transmitter 414 to allow recognition of ToF transmitter 414 by another device, such as headset 300, based on the signature of the waveform as discussed above in connection with microphone instructions 326 of headset 300.

Synchronization instructions 422 may command generation of the synchronization signal by wireless transceiver 416 at a time coordinated with the commanded ultrasonic pulse generated by ToF transmitter 414. Synchronization instructions 422 may align timing of the synchronization signal with the ultrasonic signal generated by ToF transmitter 414. In some embodiments, this synchronization provides for simultaneous transmission of the synchronization signal with the ultrasonic signal. As discussed above in connection with synchronization instructions 328 of headset 300, because the synchronization signal arrives almost instantaneously at headset 300, the time delay between the synchronization signal arrival and ultrasonic signal arrival can be used for the calculation of travel time of the ultrasonic signal from ToF transmitter 414 to headset 300.

Synchronization instructions 422 can include instructions to generate an encoded pulse to identify the start of the transmission to the receiving device, such as a sharp rising edge or envelope change, a predefined modulation pattern, or a unique ultrasonic signal that marks the start of transmission. Synchronization instructions 422 can also include instructions to decode a synchronization feature encoded in the waveform, such as the features noted above. In some embodiments, where in-band synchronization is employed, synchronization instructions 422 may include instructions to encode the signal with the transmission time embedded in the signal. As indicated above, examples of in-band synchronization can be found in U.S. Pat. Nos. 10,901,064 and 11,543,486, the disclosures of which are incorporated by reference in their entirety.

In another example embodiment, ToF transmitter 414 includes an ultrasonic transceiver, and synchronization instructions 422 may include instructions for receiving an ultrasonic pulse. Synchronization instructions 422 may include evaluating the waveform signature of a received ultrasonic signal (e.g., from user device 220 or headset 300) and matching the waveform signature with a given device to determine if a synchronization event has been initiated. The instructions may additionally include reply signal details, such as a fixed delay time after reception of the synchronization pulse and the specific waveform to send after the delay in response to the received signal.

Alternatively, soundbar 400 could send the ultrasonic signal for initiating synchronization. In such an arrangement, synchronization instructions 422 may also include information regarding the specific waveform to send and instructions that record the transmission time. The instructions discussed in connection with receiving the ultrasonic signal from another device may also be included in this arrangement with the addition of recording the reception time and determining the round-trip signal time (e.g., the difference between the time of initial signal transmission from the other device (e.g., user device 220 or headset 300) and when the reply signal is received, minus the set delay). The travel time of the ultrasonic signal (i.e., one-half of the round-trip time) may be saved for subsequent ToF calculations (e.g., at each microphone of headset 300).

Spatial audio instructions 424 may generally coordinate sound to the left and right ears based on a relative location of the user device 220, such as headset 300. As explained above, spatial audio instructions can be located locally at headset 300 or at a remote location, such as soundbar 400, or a portion of instructions may be located at each device. Like spatial audio instructions 330 located at headset 300, when located at soundbar 400, spatial audio instructions 424 provide commands or data that enable the headset to render sound in a way that mimics how sound is perceived in three-dimensional space. Spatial audio instructions 424 generally include information about the location and movement of sound sources relative to the listener's head based on the known location of headset 300, for example.

Spatial audio instructions 424 can update the spatial rendering in real time as the user turns or tilts their head, maintaining the illusion of fixed sound sources in space. Spatial audio instructions 424 dynamically control sound output based on the listener's head orientation, using real-time data. When a user moves, turns, or tilts their head, the spatial audio instructions 424 recalculate locations and intensities of virtual sound sources accordingly.

Additionally, spatial audio instructions 424 can include information from an environment describing where each sound originates and how it should behave in response to user movement or environmental changes to dynamically shape the sound field to match how the sound would be heard in the real world. For example, if a sound is supposed to originate from the left side of the listener and the user turns their head to the right, the spatial audio instructions 424 will adjust the output so that the sound continues to appear as if it's still coming from the same fixed point in space, which is now located behind the user's head. This continuous recalibration ensures that the auditory illusion remains stable and convincing, creating the perception that certain sounds are anchored in specific spatial locations, independent of the listener's movements.

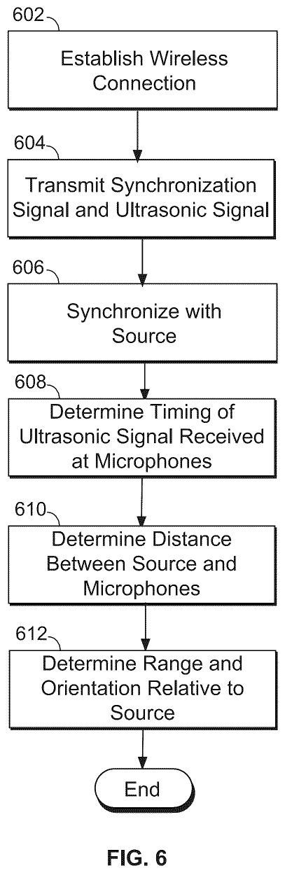

FIG. 6 depicts exemplary steps of processing a range and orientation determination for a user device (e.g., user device 220) in accordance with an embodiment of the present disclosure using RF out-of-band synchronization. Although steps are depicted in a certain order for FIG. 6, steps may be removed, modified, or substituted, and additional steps may be added in certain embodiments, and in some embodiments, the order of certain steps may be modified.

Processing starts at step 602, where a wireless connection is established between the user device (e.g., user device 220) and a ToF device (e.g., ToF device 218) via an RF connection, such as Bluetooth. In the example discussed below, user device 220 may be an audio device (e.g., headset 300) and ToF device 218 may be incorporated into another device (e.g., soundbar 400). The discussion below focuses on the example embodiment including headset 300 and soundbar 400. It is understood, however, that a variety of other user devices could be used in place of headset 300 and a variety of other ToF devices could be used in place of soundbar 400.

The wireless connection between headset 300 and soundbar 400 can be established automatically when a person enters the room by integrating presence detection technologies and pre-configured pairing protocols. For example, the system may utilize motion sensors, infrared detectors, an ultrasonic transceiver (e.g., ToF device 218 in FIG. 2) or Bluetooth beacons to detect the presence of an individual. Once presence is confirmed, the system identifies headset 300 based on a unique identifier, such as a previously paired Bluetooth address or a user profile stored in the system. Once the connection has been established, processing may continue to step 604.

At step 604, a synchronization signal and an ultrasonic signal are sent from soundbar 400. Soundbar 400 can be configured to emit a synchronization signal via wireless transceiver 416 and an ultrasonic signal via ToF transmitter 414 (i.e., the ultrasonic emitter) to facilitate timing coordination and distance measurement for associated devices. The synchronization signal may be a radio frequency (RF) transmission, generated and broadcasted via wireless transceiver 416 integrated into soundbar 400. This RF signal acts as a precise timing reference. The synchronization signal and the ultrasonic signal may be sent simultaneously. This concurrent emission ensures that the timing information carried by the RF signal can be precisely matched with the ultrasonic signal's reception time, thereby enhancing the accuracy of synchronization and spatial measurements. After the signals are sent, processing may continue to step 606.

Headset 300 (the user device) receives the RF signal (i.e., the synchronization signal) at transceiver 310 at step 606 and determines it is from the ToF device (e.g., soundbar 400 with the ultrasonic emitter). The time of arrival (t₀) of the RF signal at transceiver 310 (i.e., the receive time) is essentially the same as the transmission time from transceiver 416. The arrival time (t₀), therefore, is recorded as the send time for the ultrasonic signal from ToF transmitter 414 to synchronize timing of the ultrasonic signal between ToF transmitter 414 and headset 300. Processing may continue to step 608 after synchronization is complete (i.e., after the send time is recorded).

At step 608, ultrasonic signals are received at microphones 306, and the respective receive times are determined. Microphones 306 can determine that the ultrasonic signal is from the specific ultrasonic emitter of the ToF device. For example, microphones 306 can use pulse detection algorithms, which scan the incoming signal stream for recognizable ultrasonic pulses that meet predefined criteria (e.g., specific modulation patterns or timing intervals). A valid pulse may be identified by evaluating the waveform signature of the ultrasonic signal and matching the waveform signature with a given ToF device. In the example embodiment, microphone 312 receives the ultrasonic signal at time (t₃₁₂), microphone 314 receives the ultrasonic signal at time (t₃₁₄), microphone 316 receives the ultrasonic signal at time (t₃₁₆), and microphone 318 receives the ultrasonic signal at time (t₃₁₈). After the arrival times are determined and recorded, processing may continue to step 610.

At step 610, the distance between ToF transmitter 414 and microphones 306 is determined based on the transmission and receive times of the ultrasonic signal at microphones 306. The ultrasonic pulse travels at the speed of sound, and distance may be calculated based on the difference between ultrasonic signal emission time (t₀) and the time (t₃₁₂, t₃₁₄, t₃₁₆, t₃₁₈) the ultrasonic signal is received at each microphone 312, 314, 316, 318. Accordingly, the distance from ToF transmitter 414 to each microphone 312, 314, 316, 318 can be calculated (Distance=Time of Flight×Speed of Sound). The time of flight to microphone 312 is (t₃₁₂-t₀), time of flight to microphone 314 is (t₃₁₄-t₀), time of flight to microphone 316 is (t₃₁₆-t₀), and time of flight to microphone 318 is (t₃₁₈-t₀). The time of flight for each microphone can be input to the distance formula above and provide the distance (d₃₁₂) to microphone 312, the distance (d₃₁₄) to microphone 314, the distance (d₃₁₆) to microphone 316, and the distance (d₃₁₈) to microphone 318. The distances generally provide known locations for the microphones 312, 314, 316, 318 relative to ToF transmitter 414. Processing can then proceed to step 612.

At step 612, spatial information can be determined based on the distances between ToF transmitter 414 and microphones 306 (i.e., based on the transmission and receive times of the ultrasonic signal at microphones 306 as discussed above). Specifically, the range and orientation (i.e., spatial information) is determined using distances d₃₁₂, d₃₁₄, d₃₁₆, d₃₁₈. As discussed above, a single microphone may be used to determine the distance (i.e., range) between the user device (e.g., headset 300) and the ToF device. Using more than one microphone may provide greater accuracy. For example, by averaging the distances measured by microphones 306 on both ear cups 302, 304, the system can determine the approximate distance (range) from the emitter to the center of headset 300.

The difference between distances d₃₁₂ and d₃₁₆ or between distances d₃₁₄ and d₃₁₈ indicates the relative orientation of headset 300 relative to ToF transmitter 414. If the headset is turned at an angle, the ultrasonic signal will reach one microphone earlier than the others. After sequential measurements and/or with the use of IMU data, by comparing these time differences, one can infer the yaw (left/right rotation), pitch (up/down tilt), and roll (rotation around the central axis) of headset 300. The direction that the user device (headset 300) is facing can be determined based on one of the microphones being located closer to a front-facing surface of the ToF device than another one of the microphones. For example, for headset 300, if one of microphones 316, 318 on right ear cup 304 receives the signal earlier than one of microphones 312, 314 on the left ear cup 302, the headset is likely rotated to the left. Using four microphones (two per ear cup) increases spatial resolution. In some embodiments, three microphones may be utilized with two on one cup (e.g., with a lateral distance between them) and one on an opposite cup. Such configurations enable triangulation algorithms to better estimate not only the direction to the emitter but also subtle head movements, making it useful for applications in virtual reality, motion tracking, or human-computer interaction. In some embodiments, more microphones may be utilized for further precision and/or two microphones may be utilized (e.g., on a single cup, or only on opposite cups) with a corresponding decrease in precision, particularly as to direction/orientation.

As explained above, in some embodiments, multiple ultrasonic emitters are used and placed throughout a room (e.g., to establish trilateration). When multiple ultrasonic emitters (beacons) are used, the coordinate location of a user device (e.g., user device 220 or headset 300) in space can be determined (i.e., trilateration can be used to determine user location in three-dimensional space). For example, the steps of FIG. 6 may be used to determine distance information from microphones 306 to each of the ultrasonic emitters. The synchronization step may be needed only for one emitter, however, if the other emitters transmitted at known time delays from the synchronized emitter.

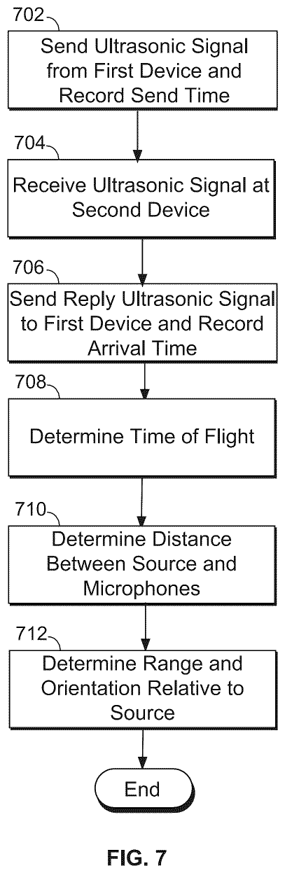

FIG. 7 depicts exemplary steps of processing a range and orientation determination for the user device including synchronizing devices using ultrasonic transceivers at each device in accordance with an embodiment of the present disclosure. Although steps are depicted in a certain order for FIG. 7, steps may be removed, modified, or substituted, and additional steps may be added in certain embodiments, and in some embodiments, the order of certain steps may be modified.

Processing starts at step 702, where an ultrasonic signal is sent from a first device and the send time is recorded at the first device. In the example embodiment, the first device may be a user device (e.g., user device 220) or a ToF device (e.g., ToF device 218). In the example discussed below, user device 220 may be an audio device (e.g., headset 300) and ToF device 218 may be incorporated into another device (e.g., soundbar 400). The discussion below relates to the example embodiment including headset 300 and soundbar 400. It is understood, however, that a variety of other user devices could be used in place of headset 300 and a variety of other ToF devices could be used in place of soundbar 400.

As discussed above, the ultrasonic signal may be an ultrasonic signal having a specific waveform with features indicating the start of the signal for identification by a second device (i.e., the receiving device). For example, the signal may have a well-defined structure, such as a rising edge, pulse onset, or unique waveform pattern. Although the receiving device may not know the absolute time this signal was transmitted, it knows exactly what the transmitted signal looks like and can detect its arrival at each microphone with high precision. After the ultrasonic signal is sent and its send time is recorded, processing continues to step 704.

At step 704 the synchronization signal is received at the second device. In the example embodiments, the second device may be the other one of user device 220 (e.g., headset 300) or ToF device 218 (e.g., soundbar 400). After the signal is received at the second device, a predetermined fixed delay, known to the first device, may be initiated before proceeding to step 706.

At step 706 an ultrasonic reply signal is sent from the second device to the first device and the time of arrival at the first device is recorded. The round-trip time of the signal may then be determined (i.e., the difference between the time of initial signal transmission from headset 300 to when the reply signal is received, minus the fixed delay). The travel time (i.e., one-half of the round-trip time) of the ultrasonic signal may be saved for subsequent ToF calculations at each microphone of the user device (e.g., user device 220 or headset 300). Processing then continues to step 708.

In some embodiments, Steps 702-706 may be eliminated by using an in-band synchronization signal having a timing reference embedded directly within the ToF ultrasonic signal emitted by the source, as discussed above. This allows the user device to achieve precise timing synchronization without requiring a separate communication link or hardware signal.

At step 708 the time of flight is determined. The time of flight may be determined at each microphone of the user device. For example, when headset 300 is the first device, the time of flight may be set as the travel time (t₃₁₂, t₃₁₄, t₃₁₆, t₃₁₈) to each microphone 312, 314, 316, 318. In embodiments where the ToF device (e.g., ToF device 218 or soundbar 400) acts as the first device and in-band synchronization is employed, this may involve multiple back-and-forth signal transmissions based on the number of microphones used. In order to measure the orientation of user device 220, however, synchronization is not required. The travel times (t₃₁₂, t₃₁₄, t₃₁₆, t₃₁₈) can each have an unknown synchronization error, but because the differences between the times are what is needed to calculate the orientation, the synchronization error is only relevant for the range/position calculation, not the orientation calculation. Processing then continues to step 710.

At step 710 the distance between the source (e.g., ToF device) and microphones of the user device is determined. This can be done in a manner like that discussed above in connection with step 610 of FIG. 6. Specifically, in the example embodiment, the distance from the source to each microphone 312, 314, 316, 318 can be calculated (Distance=Time of Flight×Speed of Sound). The time of flight to microphone 312 is (t₃₁₂), time of flight to microphone 314 is (t₃₁₄), time of flight to microphone 316 is (t₃₁₆), and time of flight to microphone 318 is (t₃₁₈). The time of flight for each microphone can be input to the distance formula above and provide the distance (d₃₁₂) to microphone 312, the distance (d₃₁₄) to microphone 314, the distance (d₃₁₆) to microphone 316, and the distance (d₃₁₈) to microphone 318. Processing then continues to step 712.

At step 712 the range and orientation (i.e., spatial information) of the user device can be determined using distances d₃₁₂, d₃₁₄, d₃₁₆, d₃₁₈. As discussed above, a single microphone may be used to determine the distance (i.e., range) between the user device (e.g., headset 300) and ToF device (e.g., soundbar 400). Using more than one microphone may provide greater accuracy. For example, by averaging the distances measured by the microphones on both ear cups 302, 304, the system can determine the approximate distance (i.e., range) from the emitter to the center of the headset.

The difference between distances d₃₁₂ and d₃₁₆ or between distances d₃₁₄ and d₃₁₈ indicates the relative orientation of headset 300 relative to the ToF device. If headset 300 is turned at an angle, the ultrasonic signal will reach one microphone earlier than the others. By comparing these time differences, one can infer the yaw (left/right rotation), pitch (up/down tilt), and roll (rotation around the central axis) of headset 300. The direction that the user device (i.e., headset 300) is facing can be determined based on one of the microphones being located closer to a front-facing surface of the ToF device than another one of the microphones. For example, for headset 300, if one of microphones 316, 318 on right ear cup 304 receives the signal earlier than one of microphones 312, 314 on the left ear cup 302, the headset is likely rotated to the left. Using four microphones (two per ear cup) increases spatial resolution. This configuration enables triangulation algorithms to better estimate not only the direction to the emitter but also subtle head movements, making it useful for applications in virtual reality, motion tracking, or human-computer interaction.

As explained above, in some embodiments, multiple ultrasonic emitters are used and placed throughout a room. When multiple ultrasonic emitters (beacons) are used, the coordinate location of a user device (e.g., user device 220 or headset 300) in space can be determined (i.e., trilateration can be used to determine user location in three-dimensional space). For example, the steps of FIG. 7 may be used to determine distance information from microphones 306 to each of the ultrasonic emitters. The synchronization step may only be needed for one emitter, however, if the other emitters transmitted at known time delays from the synchronized emitter. In one example, to find the position of the user wearing headset 300 in the room, a single ToF device 218 can be used in system 200. If three or more microphones on the headset 300 receive the sound and the synchronization signal, three times are measured, and those can be used to trilaterate the position of ToF device 218 with respect to headset 300. As a result, the position of ToF device 218 is known relative to the user which is useful for spatial audio. The user's position in this example, however, is not known because it depends on the unknown orientation of the user's head with respect to the room. In another example, multiple emitters can be placed in the room, as discussed above. The three-dimensional position and orientation of the user with respect to the room can be determined in this example by sending at least three pulses from the at least three emitters (i.e., ToF devices 218), and obtaining a range associated with each emitter-microphone combination.

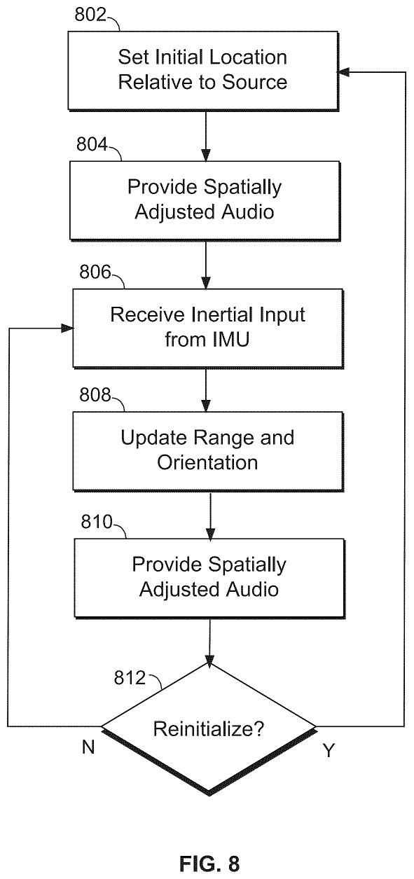

FIG. 8 depicts exemplary steps of updating a user's location in accordance with an embodiment of the present disclosure. Although steps are depicted in a certain order for FIG. 8, steps may be removed, modified, or substituted, and additional steps may be added in certain embodiments, and in some embodiments, the order of certain steps may be modified.

Processing starts at step 802, where an initial location is set for the user. The initial location may include the range and orientation information generated at step 612 in FIG. 6 or step 712 in FIG. 7. After the initial location (range and orientation) is set, processing may continue to step 804.

At step 804, spatial audio is adjusted for the initial location (range and orientation) based on the range and orientation received from step 802. This adjustment may include the sound provided at various portions of speaker array 214 and/or headset 300 being modified based on the user's range and orientation as discussed above. For example, the spatial audio adjustment can update the spatial rendering in real time as the user turns or tilts their head, maintaining the illusion of fixed sound sources in space. This update can dynamically control sound output based on the listener's head orientation, using real-time data. When a user turns, tilts, or nods their head, the spatial audio adjusts virtual sound sources accordingly. After the spatial audio is adjusted, processing may proceed to step 806.

At step 806, adjustments in user location are received from a sensor at the user device (e.g., inertial measurements from IMU 308 in headset 300). As explained above with respect to IMU 308, accelerometers and gyroscopes track user location after the initial range and orientation determination. For example, the sensor (e.g., IMU 308) provides updates to rotational orientation and linear displacement of the user device (e.g., headset 300). Processing then proceeds to step 808.

At step 808, the range and orientation of the user device are updated based on the changes in rotational orientation and linear displacement provided by IMU 308. This includes modifying the initial range and orientation established at step 802 by subsequent user movement captured by IMU 308. This update maintains the illusion of fixed-location sound sources in space, even as the listener turns, tilts, or moves their head. IMU 308 adjustments handle the continuous acquisition of motion data and ensure synchronized sampling of all six axes. Processing then proceeds to step 810.

At step 810, spatial audio is again updated based on the new range and orientation information. Like step 804, spatial audio adjustment may include the sound provided at various portions of speaker array 214 and/or headset 300 being modified based on the user's range and orientation as discussed above. Processing then proceeds to step 812.

At step 812, a decision is made whether to reinitialize the user's location with the ToF device. If no reinitialization is required the processing returns to step 806, where IMU 308 is used to update range and orientation information as discussed above. Updating via IMU 308 may occur at set times in a generally continuous manner, or if triggered by another event (e.g., synchronizations at the start of new multimedia content, or related to significant motion activity). Location (i.e., range and orientation) may be updated using the ToF device to minimize the buildup of errors in range and orientation from the IMU updates. Updating range and orientation via the ToF device may occur at set times in a generally continuous manner, or if triggered by another event (e.g., synchronizations at the start of new multimedia content, or related to significant motion activity).

When an update is needed based on the ToF device, processing returns to step 802. As explained above, the range and orientation information generated at step 612 in FIG. 6 or step 712 in FIG. 7 may be used to reinitialize location. This may include running through the entire process in FIG. 6 or FIG. 7. Alternatively, because the initial transmission time is known in each of those processes for synchronization, the elapsed time from the initial time may be used for subsequent updates without requiring another synchronization. For example, the retransmission time for the ultrasonic signal may occur at known intervals from the initial time, resulting in the retransmission times also being known. Subsequent ToF calculations, therefore, can be made using the known retransmission times without requiring additional synchronization.

The foregoing description includes exemplary embodiments in accordance with the present disclosure. These examples are provided for purposes of illustration only, and not for purposes of limitation. It will be understood that the present disclosure may be implemented in forms different from those explicitly described and depicted herein and that various modifications, optimizations, and variations may be implemented by a person of ordinary skill in the present art, consistent with the following claims.

What is claimed is:

1. A method of determining spatial information for a device, comprising:
receiving, at a first microphone of the device, an ultrasonic signal;
determining that the received ultrasonic signal is from an ultrasonic emitter;
identifying a first receive time of the received ultrasonic signal when the received ultrasonic signal is determined to be from the ultrasonic emitter;
receiving, at a second microphone of the device, the ultrasonic signal;
determining that the received ultrasonic signal at the second microphone is from the ultrasonic emitter;
identifying a second receive time of the received ultrasonic signal for the second microphone when the received ultrasonic signal for the second microphone is determined to be from the ultrasonic emitter; and
determining an orientation of the device based on a difference between the first receive time and the second receive time.

2. The method of claim 1, further comprising determining a direction that the device is facing, and wherein the direction that the device is facing is determined based on one of the first microphone or the second microphone being located closer to a front-facing surface of the device.

3. The method of claim 1, further comprising:
receiving, at a third microphone of the device, the ultrasonic signal;
determining that the received ultrasonic signal at the third microphone is from the ultrasonic emitter;
identifying a third receive time of the received ultrasonic signal for the third microphone when the received ultrasonic signal for the third microphone is determined to be from the ultrasonic emitter; and
further determining additional spatial information based on a time of transmission from the ultrasonic emitter, the first receive time, the second receive time, and the third receive time.

4. The method of claim 3, further comprising determining a coordinate location for the device in space based on the first receive time, the second receive time, and the third receive time.

5. The method of claim 4, wherein the orientation or the coordinate location is determined based on trilateration of distances determined from the first receive time, second receive time, and third receive time.

6. The method of claim 3, further comprising determining a range of the device based on one or more of the first receive time, the second receive time, or the third receive time.

7. The method of claim 6, wherein the device is an audio device, and wherein the range and the orientation establish a location for the audio device, and wherein the audio device selectively provides a spatially adjusted audio output based on the location.

8. The method of claim 7, wherein the location is an initial location for the audio device.

9. The method of claim 7, further comprising:
receiving inertial measurements from one or more sensors of the audio device;
tracking a change in the range or the orientation of the audio device based on the inertial measurements; and
changing the spatially adjusted audio output based on the change in the range or the orientation.

10. The method of claim 9, wherein the one or more sensors comprise a multi-axis inertial measurement unit including at least one gyroscope and at least one accelerometer.

11. The method of claim 3, further comprising:
receiving, at a fourth microphone of the device, the ultrasonic signal;
determining that the received ultrasonic signal at the fourth microphone is from the ultrasonic emitter;
identifying a fourth receive time of the received ultrasonic signal for the fourth microphone when the received ultrasonic signal for the fourth microphone is determined to be from the ultrasonic emitter; and
determining the orientation and the additional spatial information based on the time of transmission, the first receive time, the second receive time, the third receive time, and the fourth receive time.

12. The method of claim 1, further comprising:
receiving, at the device, a synchronization signal;
determining, based on the synchronization signal, a time of transmission from the ultrasonic emitter located at a first location remote from the device; and
determining spatial information based on the time of transmission and one or more of the first receive time or the second receive time, wherein the spatial information includes at least a range between the device and the first location.

13. The method of claim 12, wherein the synchronization signal comprises a radio frequency signal transmitted by a wireless transceiver, wherein the ultrasonic signal is transmitted by the ultrasonic emitter at an ultrasonic transmission time, and wherein the radio frequency signal is transmitted at a fixed timing relative to the ultrasonic transmission time.

14. The method of claim 12, wherein the ultrasonic signal comprises a first ultrasonic signal, the ultrasonic emitter comprises a remote ultrasonic emitter, and wherein the synchronization signal comprises a second ultrasonic signal, and further comprising transmitting, from a device ultrasonic emitter at a fixed delay from receipt of the synchronization signal, a reply signal to the remote ultrasonic emitter, wherein the first ultrasonic signal is sent after the reply signal, wherein the time of transmission of the first ultrasonic signal is known to the device based on the synchronization signal and the reply signal.

15. A user device, comprising:
a plurality of microphones;
a radio frequency (RF) transceiver;
an inertial measurement unit (IMU);
a memory comprising instructions stored thereon; and
processing circuitry coupled to the plurality of microphones, the RF transceiver, the IMU, and the memory, wherein the processing circuitry is configured to execute the instructions to:
receive, at a first microphone of the device, an ultrasonic signal;
determine that the received ultrasonic signal is from an ultrasonic emitter;
identify a first receive time of the received ultrasonic signal when the received ultrasonic signal is determined to be from the ultrasonic emitter;
receive, at a second microphone of the device, the ultrasonic signal;
determine that the received ultrasonic signal at the second microphone is from the ultrasonic emitter;
identify a second receive time of the received ultrasonic signal for the second microphone when the received ultrasonic signal for the second microphone is determined to be from the ultrasonic emitter; and
determine an orientation of the user device based on a difference between the first receive time and the second receive time.

16. The user device of claim 15, wherein the processing circuitry is further configured to execute the instructions to determine that the received ultrasonic signal is from the ultrasonic emitter, identify the first receive time after the received ultrasonic signal is determined to be from the ultrasonic emitter, and identify the second receive time after the received ultrasonic signal is determined to be from the ultrasonic emitter.

17. The user device of claim 15, wherein the plurality of microphones further comprises a third microphone, wherein the processing circuitry is further configured to:
identify a third receive time of the received ultrasonic signal at the third microphone; and
determine the orientation and a range of the user device based on a time of transmission, the first receive time, the second receive time, and the third receive time.

18. The user device of claim 17, wherein further comprising determining a coordinate location for the user device in space based on the time of transmission, the first receive time, the second receive time, and the third receive time.

19. A system, comprising:
an ultrasonic emitter; and
a user device, wherein the ultrasonic emitter is located at a first location remote from the user device, the user device comprising:
a plurality of microphones;
a radio frequency (RF) transceiver;
an inertial measurement unit (IMU);
a memory comprising instructions stored thereon; and
processing circuitry coupled to the plurality of microphones, the RF transceiver, the IMU, and the memory, wherein the processing circuitry is configured to execute the instructions to:
receive, at a first microphone of the device, an ultrasonic signal;
determine that the received ultrasonic signal is from the ultrasonic emitter;
identify a first receive time of the received ultrasonic signal when the received ultrasonic signal is determined to be from the ultrasonic emitter;
receive, at a second microphone of the device, the ultrasonic signal;
determine that the received ultrasonic signal at the second microphone is from the ultrasonic emitter;
identify a second receive time of the received ultrasonic signal for the second microphone when the received ultrasonic signal for the second microphone is determined to be from the ultrasonic emitter; and
determine an orientation of the user device based on a difference between the first receive time and the second receive time.
